(19) United States
(12) Patent Application Publication
(10) Pub. No.: US 2026/0048705 A1
(43) Pub. Date: Feb. 19, 2026

(54) Passenger Vehicle With a Roof Decorative Trim

(71) Applicant: Bayerische Motoren Werke Aktiengesellschaft, Muenchen (DE)

(72) Inventor: Peter BIECKER, Muenchen (DE)

(21) Appl. No.: 19/101,650

(22) PCT Filed: Sep. 5, 2023
(86) PCT No.: PCT/EP2023/074245

§ 371 Date: Feb. 6, 2025

(30) Foreign Application Priority Data
Sep. 20, 2022 (DE) 10 2022 124 113.0

(51) Int. Cl. B60R 13/04; B62D 25/06; F16B 5/12

(52) U.S. Cl. CPC B60R 13/04; B62D 25/06; F16B 5/123

(57) ABSTRACT

A passenger vehicle has a vehicle roof fixed on the vehicle body and designed as a hardtop, a body outer skin spaced apart from the vehicle roof via a roof gap, and a roof decorative trim, which at least partially covers the roof gap. The decorative trim profile is fastened to the body by at least one retaining clip. The retaining clip has at least one latching nose on its side face facing away from the vehicle roof and at least one recess on its side face facing away from the body. The vehicle roof has at least one roof projection on its side facing the retaining clip. The decorative trim profile has at least one latching projection, which is operatively connected to the at least one latching nose, at least one guide projection, which is operatively connected to the at least one recess, and at least one terminating projection, which is operatively connected to the roof projection.

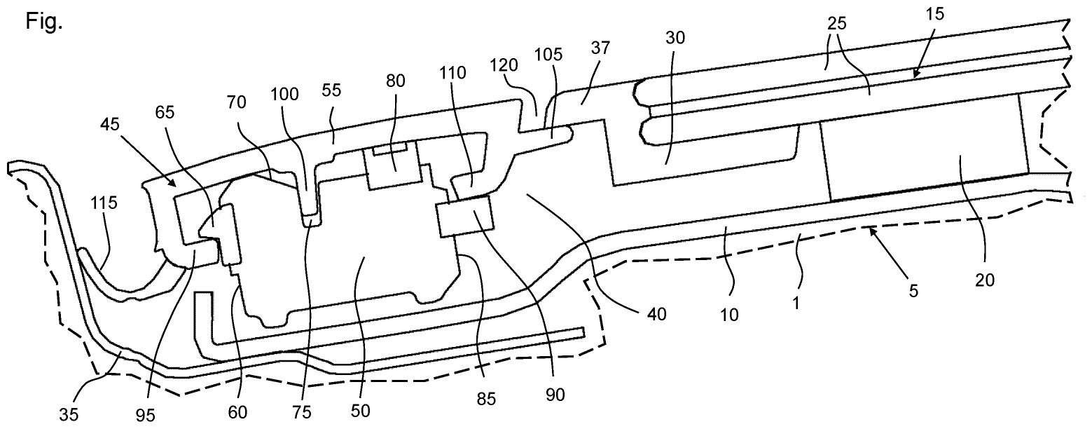

### BACKGROUND AND SUMMARY

The present invention relates to a passenger vehicle with a roof decorative trim.

It is known that the gaps between an outer skin and a fixed roof of a passenger vehicle are covered using roof decorative trim. This roof decorative trim has decorative trim profiles for this purpose, which are attached by means of retaining clips fastened to the body. In practice, however, this leads to effects that do not always do justice to the desired visual impression.

The object of the present invention is to overcome this disadvantage.

This object is achieved by a passenger vehicle having the features of the independent claim(s).

Specifically, this object is achieved by a passenger vehicle having a vehicle roof fixed on the vehicle body and designed as a hardtop roof, a body outer skin spaced apart from the vehicle roof via a roof gap, and a roof decorative trim which at least partially covers the roof gap, the decorative trim profile of which is fastened to the body by means of at least one retaining clip. The passenger vehicle is characterized in that:
the retaining clip has at least one latching nose on its side face facing away from the vehicle roof and at least one recess on its side face facing away from the body,
the vehicle roof has at least one roof projection on its side facing the retaining clip, and
the decorative trim profile has at least one latching projection which is operatively connected to the at least one latching nose, at least one guide projection which is operatively connected to the at least one recess, and at least one terminating projection which is operatively connected to the roof projection.

The at least one latching nose is preferably located solely on the side surface facing away from the vehicle roof, while no further latching noses are provided at other points on the retaining clip. The decorative trim profile is preferably designed as an extruded body. The guide body provided on the decorative trim profile acts as a guide element and supports the decorative trim profile in its longitudinal direction. The terminating projection provided according to the invention supports the roof decorative trim profile against the roof projection. It also prevents a view into the roof gap.

The previously disclosed means advantageously enable a tolerance compensation between the roof decorative trim and the fixed roof in a direction away from the body and thus an aesthetically advantageous, monolithic appearance of the roof region of the passenger vehicle according to the invention. In addition, the above-mentioned means advantageously enable comparatively simple and reliable installation of the roof decorative trim on the passenger vehicle.

According to a preferred embodiment of the present invention, it is provided that at least one first spring element is located on the side face of the retaining clip facing away from the body, against which the decorative trim profile rests. This allows a desired pretension between the decorative trim profile and the retaining clip to be set in an advantageous manner, so that the desired tolerance compensation is further improved.

This also applies in the case of a further preferred embodiment, according to which at least one second spring element is located on a side face of the retaining clip facing the vehicle roof, against which a spring projection projecting from the decorative trim profile rests.

According to another preferred embodiment, it is provided that a sealing lip located on the decorative trim profile rests against the body outer skin. This advantageously makes it more difficult for water or dirt to penetrate the body or even completely prevents this.

The following is a detailed, non-prejudicial, in particular limiting, description of an exemplary embodiment of the present invention with reference to the single FIGURE, which is not to scale.

### BRIEF DESCRIPTION OF THE DRAWING

The single FIGURE symbolically depicts a passenger vehicle according to an embodiment of the invention, the roof region of which is partially shown in section in a side view.

### DETAILED DESCRIPTION OF THE DRAWING

Referring to the FIGURE, the passenger vehicle 1 comprises a body 10 (partially illustrated here) to which a vehicle roof 15 designed as a fixed (hardtop) roof is fixed by means of an adhesive bead 20. The vehicle roof 15 shown in this exemplary embodiment has two glass panes 25 spaced apart from each other, which are connected to each other at the edges by a foam surround 30. A part of the foam surround 30 shown on the left in the figure protrudes from the foam surround 30 as a roof projection 37. It should be noted that (although not shown here) a vehicle roof 15 not having a foam surround 30 may be provided. In this case, part of a glass pane 25 protrudes as a roof projection 37.

There is also a body outer skin 35 on the body , which is spaced apart from the vehicle roof 15. Consequently, there is a roof gap 40 between the body outer skin 35 and the vehicle roof 15. The roof gap 40 is covered by a roof decorative trim 45, which comprises a decorative trim profile 55 attached to the body 10 by means of a retaining clip 50.

The retaining clip 50 itself has a latching nose 65 on its side face 60 facing away from the vehicle roof 15 and a recess 75 on its side face 70 facing away from the body 15 oriented or extending orthogonally to the paper plane of the figure. On the same side, but at a slight distance from the recess 75 in the direction of the roof projection 37, a first spring element 80 is provided, against which the decorative trim profile 55 rests. Finally, the retaining clip 50 has a second spring element 90 on its side face 85 facing the roof projection 37, which projects in the direction of the roof projection 37.

The decorative trim profile 55, for its part, has a latching projection 95 which is operatively connected to the latching nose 65, a guide projection 100 which is operatively connected to the recess 75, and a terminating projection 105 which is operatively connected to the roof projection 37. Finally, in the region of the terminating projection 105, the decorative trim profile 55 has a spring projection 110 which rests on the second spring element 90 under pretension. Finally, the decorative trim profile 55 has a sealing lip 115 on its side face 60, which rests against the body outer skin 35.

As can be seen from the figure, the lower side of the decorative trim profile 55 is acted upon by the first spring element 80 directly and indirectly via the operative connection between the second spring element 90 and the spring projection 110 with an upwardly acting spring force. In other words, the decorative trim profile 55 is resiliently biased in a direction opposite the body 10 by the material properties of the first spring element 80, the material properties of the second spring element 90 and the inherent elastic properties of the spring projection 110.

The latching projection 95, which in the figure rests against the latching nose 65 from below, and the terminating projection 105, which also rests against the roof projection 37 from below, hold the decorative trim profile 55 in place against the spring force described above, so that it is secured against unintentional release in conjunction with the guide projection 100 fastened in the recess 70. At the same time, it is elastically mounted in such a way that its surface facing away from the body 10 is flush with the surface of the vehicle roof 15 facing away from the body 10. In conjunction with a gap 120 formed between the decorative trim profile 55 and the roof projection 37, this creates a tolerance compensation between the decorative trim profile 55 and the vehicle roof 15, with which a very pleasing visual appearance of the passenger vehicle 1 in its roof region 5 is achieved.

### LIST OF REFERENCE NUMERALS

1 Passenger vehicle
5 Roof region
10 Body
15 Vehicle roof
20 Adhesive bead
25 Glass panes
30 Foam surround
35 Body outer skin
37 Roof projection
40 Roof gap
45 Roof decorative trim
50 Retaining clip
55 Decorative trim profile
60 Side face
65 Latching nose
70 Side face
75 Recess
80 First spring element
85 Side face
90 Second spring element
95 Latching projection
100 Guide projection
105 Terminating projection
110 Spring projection
115 Sealing lip
120 Gap

1.-4. (canceled)

5. A passenger vehicle, comprising:
a vehicle roof fixed on a vehicle body and designed as a hardtop roof;
a body outer skin spaced apart from the vehicle roof via a roof gap;
a roof decorative trim which at least partially covers the roof gap; and
at least one retaining clip by which the roof decorative trim is fastened to the body, wherein
the retaining clip has at least one latching nose on a side face facing away from the vehicle roof and at least one recess on a side face facing away from the body,
the vehicle roof has at least one roof projection on a side facing the retaining clip, and
the decorative trim profile has at least one latching projection which is operatively connected to the at least one latching nose, at least one guide projection which is operatively connected to the at least one recess, and at least one terminating projection which is operatively connected to the roof projection.

6. The passenger vehicle according to claim 5, wherein
at least one first spring element is located on the side face of the retaining clip facing away from the body, against which the decorative trim profile rests.

7. The passenger vehicle according to claim 6, wherein
at least one second spring element is located on a side face of the retaining clip facing the vehicle roof, against which a spring projection projecting from the decorative trim profile rests.

8. The passenger vehicle according to claim 5, wherein
a sealing lip located on the decorative trim profile rests against the body outer skin.
